(19) United States
(12) Patent Application Publication
(10) Pub. No.: US 2013/0192640 A1
(43) Pub. Date: Aug. 1, 2013

(54) SYSTEM AND METHOD FOR REMOVING DELETERIOUS CHEMICALS FROM A FIBER OPTIC LINE

(71) Applicants: Neal G. Skinner, Lewisville, TX (US); John L. Maida, JR., Houston, TX (US); Etienne M. Samson, Cypress, TX (US); David P. Sharp, Houston, TX (US); Kari-Mikko Jaaskelainen, Houston, TX (US); Michel LeBlanc, Houston, TX (US)

(72) Inventors: Neal G. Skinner, Lewisville, TX (US); John L. Maida, JR., Houston, TX (US); Etienne M. Samson, Cypress, TX (US); David P. Sharp, Houston, TX (US); Kari-Mikko Jaaskelainen, Houston, TX (US); Michel LeBlanc, Houston, TX (US)

(21) Appl. No.: 13/359,159

(22) Filed: Jan. 26, 2012

(51) Int. Cl. B08B 9/032

(52) U.S. Cl. 134/18; 134/22.11; 134/21; 134/19; 134/166 C; 134/105; 15/320

(57) ABSTRACT

According to one embodiment, the disclosure provides a system for removal of deleterious chemicals from a fiber optic line. The system may a fiber optic line having two ends, an outer tube, an optical fiber, and an inner volume, a fluid operable to move through the inner volume, the fluid operable to remove at least one deleterious chemical other than hydrogen from the fiber optic line, and a fluid controller connected to at least one end of the fiber optic line and operable to control movement of the fluid through the inner volume. According to another embodiment, the disclosure provides a method of removing a deleterious chemical from a fiber optic line. According to a third embodiment, the disclosure provides a method of removing a deleterious chemical from a fiber optic line by introducing a vacuum in an inner volume of a sealed fiber optic line in a static or cyclical manner.

### TECHNICAL FIELD

The current disclosure relates to a system and method for removing deleterious chemicals from around, on or in a fiber optic line. The deleterious chemicals may cause damage to the optical fiber in the fiber optic line or its associated jacket, shields, or other nearby components. The fiber optic line may be located in a high temperature environment, such as a wellbore. It may also be located in a low temperature environment, such as an air freight environment. The system and method may use a fluid, including a gas, liquid, or gel, or active process to remove one or more of the deleterious chemicals. In some embodiments, a single fluid may be able to remove all or substantially all of a group of deleterious chemicals. In other embodiments, a vacuum may be used to remove deleterious chemicals.

### BACKGROUND

Fiber optic lines are frequently used to detect properties, such as temperature, pressure, strain, or acoustic noise in subterranean environments, such as wellbores. Additionally, fibers are used for communication, power transmission, and other sensing functions. The optical fibers in these lines may be readily damaged in a number of ways in the downhole environment or when used for any of the functions listed above. One type of damage results from reactions with deleterious chemicals which may physically degrade the optical fiber or decrease its optical properties. For instance, hydrogen may react with the optical fiber and cause it to darken, decreasing its ability to transmit light. Reactions with hydrogen as well as reactions with many other deleterious species may progress more rapidly or take place more frequently at higher temperatures, increasing the overall rate or amount of damage to the optical fiber.

Previous techniques for decreasing this damage have focused on removal of hydrogen alone. Accordingly, techniques for removal of additional deleterious chemicals or other chemicals that are desirable to remove from the fiber optic line are needed. Techniques for the addition of beneficial chemicals are also needed.

### SUMMARY

According to one embodiment, the disclosure provides a system for removal of deleterious chemicals from a fiber optic line. The system may a fiber optic line having two ends, an outer tube, an optical fiber, and an inner volume, a fluid operable to move through the inner volume, the fluid operable to remove at least one deleterious chemical other than hydrogen from the fiber optic line, and a fluid controller connected to at least one end of the fiber optic line and operable to control movement of the fluid through the inner volume.

According to another embodiment, the disclosure provides a method of removing a deleterious chemical from a fiber optic line by introducing a fluid into an inner volume of a fiber optic line at an end of the fiber optic line, wherein the inner volume is located within an outer tube, and flowing the fluid through the inner volume of the fiber optic line in an amount and for a time sufficient to remove at least one deleterious chemical other than hydrogen from the fiber optic line.

According to a third embodiment, the disclosure provides a method of removing a deleterious chemical from a fiber optic line by introducing a vacuum in an inner volume of a sealed fiber optic line, wherein the inner volume is located within an outer tube, and maintaining the vacuum for a time sufficient to remove at least one deleterious chemical from the fiber optic line.

### BRIEF DESCRIPTION OF THE DRAWINGS

A more complete understanding of the present embodiments and advantages thereof may be acquired by referring to the following description taken in conjunction with the accompanying drawings, which describe particular embodiments of the disclosure, in which like numbers refer to similar components, and in which:

FIG. 1 illustrates an example cross section of a fiber optic line that may be used in conjunction with certain embodiments of the present disclosure;

FIG. 2A illustrates an example cross section of a co-axial fiber optic line that may be used in conjunction with certain embodiments of the present disclosure;

FIG. 2B illustrates fluid flow in a fiber optic line of FIG. 2A;

FIG. 2C illustrates alternative fluid flow in a fiber optic line of FIG. 2B;

FIG. 3 illustrates an example optical sensing system in a wellbore that may be used in conjunction with certain embodiments of the present disclosure;

FIG. 4 illustrates an example U-tube installation of a fiber optic line in a wellbore that may be used in conjunction with certain embodiments of the present disclosure; and

FIG. 5 illustrates an example J-tube installation of a fiber optic line in a wellbore that may be used in conjunction with certain embodiments of the present disclosure.

### DETAILED DESCRIPTION

The disclosure provides systems and methods for removal of deleterious or undesirable materials, such as deleterious chemicals, from around, on or in a fiber optic line. It also provides systems and methods for addition of beneficial materials around, on or in a fiber optic line.

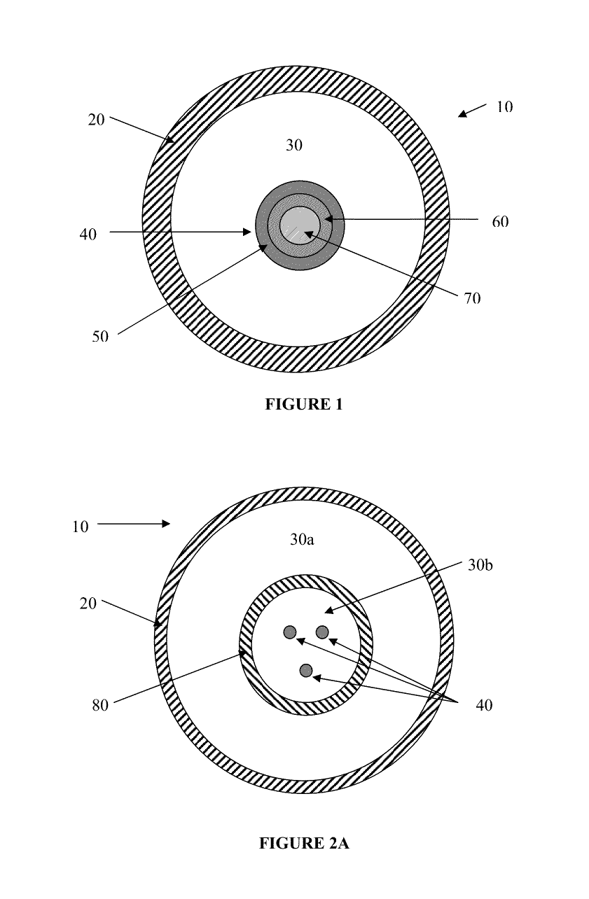

The disclosure provides a system and method for purging deleterious chemicals from a fiber optic line such as fiber optic line 10, illustrated in FIG. 1. Fiber optic line 10 may include outer tube 20, which may be made metallic. For instance, it may be made of stainless steel or another corrosion-resistant, durable material. Outer tube 20 may provide physical, chemical, or nuclear protection to the other components of fiber optic line 10 and may also allow movement and position of fiber optic line 10 to be guided or controlled. Fiber optic line 10 also includes optical fiber 40, which is operable to transmit optical signals along the length of fiber optic line 10. Optical fiber 40 may contain a core 70 and cladding 60 through which the optical signals are transmitted, along with other elements to protect core 70 or facilitate the transmission of optical signals. These other elements may include jacket 50, which may be made of a polymer such as a polyimide or acrylate. or a metal, such as aluminum or gold.

Outer tube 20 has an inner volume 30 Inner volume 30 is typically filled with air in most fiber optic lines. However, in embodiments of the present disclosure, inner volume 30 may be cyclically or continuously filled with a fluid (not shown) that removes one or more deleterious chemicals from fiber optic line 10. The fluid may be any type of fluid. For example it may be a gas, a liquid, a foam, or a gel. In specific embodiments, it may be a non-oxidizing fluid, such as nitrogen gas, or alcohol such as isopropyl alcohol.

The deleterious chemicals removed by inner volume 30 may include hydrogen, water, alcohol, toluene, hydrogen sulfide, mineral spirits, hydrocarbons, and remnant outgassing by-products from jacket 50, such as n-methyl-2 pyrrolidone, N-methyl-2 pyrrolidone (NMP) outgassed from polyimide, other components of optical fiber 40, or outer tube 20 and residual pumping fluids or borehole fluid components. Other deleterious chemicals that have a negative physical or chemical effect on any part of fiber optic line 10, including not just the optical fiber 40, but also any line coatings or claddings (including those not specifically mentioned here or illustrated in the FIGURES).

The fluid may be operable to remove any one of these deleterious chemicals other than hydrogen alone, in combination with hydrogen, or in combination with another of these deleterious chemicals. For example, nitrogen gas is operable to remove any combination of or all of the deleterious chemicals mentioned above, depending on the volume of nitrogen gas introduced to inner volume 30 over time, temperature, and the pressure of the nitrogen gas. In some embodiments multiple fluids may be used in sequence to remove deleterious chemicals. For instance, alcohol may first be introduced to the fiber optic line 10 to remove residual water, then a gas may be introduced to remove residual alcohol and optionally also other deleterious chemicals.

In some embodiments, removal of a deleterious chemical may involve its physical removal from fiber optic line 10. In other embodiments, removal of the deleterious chemical may involve reaction of the deleterious chemical with the fluid, or catalysis of a reaction of the deleterious chemical with another chemical present in fiber optic line 10 to produce a chemical product. This product may be non-deleterious or it may be deleterious, but more readily removed or less deleterious than the initial deleterious chemical. For example, the fluid may contain a hydrogen scavenger or another material able to trap or neutralize deleterious chemicals.

Although in example embodiments herein, the use of a fluid to remove deleterious chemicals is discussed for illustrative purposes, in other example embodiments, a vacuum may be used in place of or in addition to the fluid. For proposes herein, a vacuum may include any pressure less than ambient. For purposes herein, by vacuum is meant the reduction of pressure relative to the prevalent pressure in the tube so as to favor fluid flow within the tube (from one section to another, or from one section to the outside), or to favor outgassing from the various materials in the tube.

In one specific embodiment, a vacuum may be applied to fiber optic line 10 in order to cause deleterious chemicals to move out the line. Such vacuum may remove deleterious chemicals via Brownian migration, adsorption, combination, or other chemical or mechanical process. In the process, liquid deleterious chemicals may also be vaporized, which may facilitate their movement. In another particular embodiment, a vacuum may be used in a two-step process with a liquid, foam, or gel fluid. For instance, a liquid, such as an alcohol, may be introduced into fiber optic line 10 and then generally removed. Next, a vacuum may be applied to cause evaporation and removal of residual alcohol.

Furthermore, the fluid or vacuum may be used, in some embodiments, to remove materials from fiber optic line 10 that are not deleterious to line, but are otherwise undesirable in the line. For instance, various hazardous materials present in the line may be removed. Specifically, nuclear moderators, neutron adsorbers, marker isotopes, or other tagging and locating items in the fiber optic line.

In another embodiment, the fluid or vacuum may be used to prevent or reduce a deleterious process, such as recirculate boiling, delamination, debonding, and similar processes, that harms the fiber optic line, rather than to remove a deleterious chemical.

In still another embodiment, the fluid or vacuum may be used to introduce a beneficial material to the fiber optic line. For instance, a monitoring chemical with a limited shelf life or half life may be introduced and replaced. Other beneficial chemicals that may be introduced include samarium oxide, gadolinium, nanomaterials, and similar materials.

The precise detrimental or undesirable material to be removed or beneficial materials to be introduced, the fluid or vacuum selected to accomplish this, and the method for introducing or removing the fluid or vacuum may vary depending on where the fiber optic line is located and the conditions to which it is subjected as well as on the actual use of the fiber optic line. Although embodiments herein are described particularly for the wellbore environment, variations for fiber optic lines used in communication, power transmission, and other sensing functions may be envisioned using the disclosure herein.

In some embodiments in which certain materials, such a gel used for acoustic coupling to the optical fiber or a coating used to metalize a section of a sensor, are desirably present in fiber optic line 10, any of the above processes may be tailored to avoid or minimize removal of these beneficial materials from the fiber optic line. Such tailoring might be used, in particular, in embodiments in which claddings or jackets may be used as a membrane for selective coupling of components. Furthermore, the above processes may be tailored to avoid or reduce effects on any physical electrical conductors present in or near fiber optic line 10. Such effect might include oxidation, sulphidation, and similar effects. It may be particularly useful to avoid such effects in embodiments in which the fiber optic line is used in the electrical power industry.

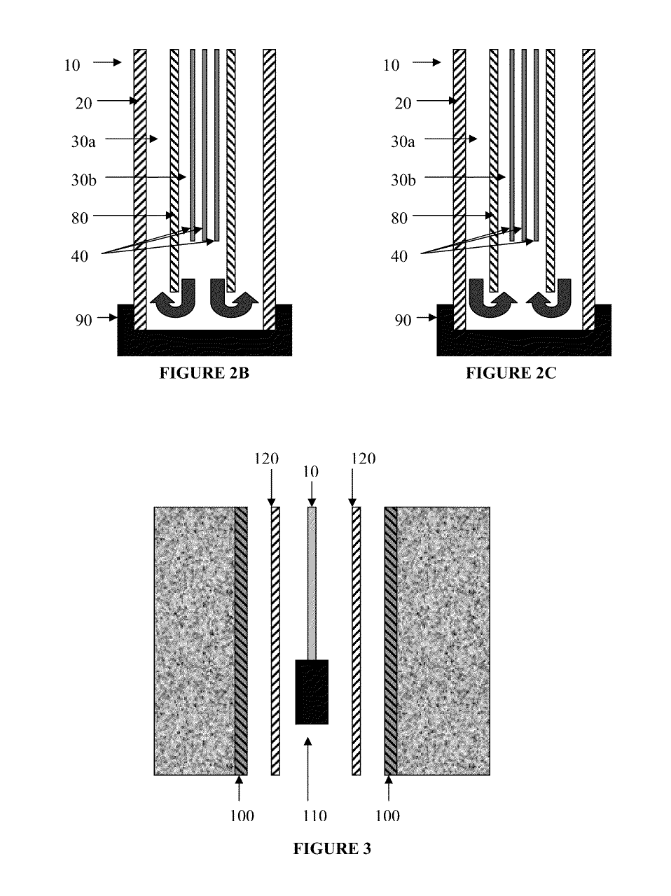

In an alternative embodiment, shown in FIGS. 2A, 2B and 2C, fiber optic line 10 may be a co-axial fiber optic line including outer tube 20, and inner tube 80, which may also be metallic or another non-corrodible and durable material, and end cap 90. Optical fibers 40 are located inside of inner tube 80. Inner volume 30a is located between outer tube 20 and inner tube 80. Inner volume 30b is located within inner tube 80. As illustrated in FIG. 2B, in one embodiment fluid may flow down inner volume 30b until it reaches end cap 90, at which point it may flow up inner volume 30a to exit fiber optic line 10 from the same end at which it entered. Alternatively, as illustrated in FIG. 2C, fluid may flow down inner volume 30a until it reaches end cap 90, at which point it may flow up inner volume 30b to exit fiber optic line 10 from the same end at which it entered. Further details regarding such a co-axial fiber optic line and alternatives thereof are provided in U.S. Pat. No. 8,090,227, which is incorporated in material part by reference herein.

It will be understood that multiple optical fibers 40 are illustrated for exemplary purposes only and that in various alternative embodiments non co-axial fiber optic line 10 illustrated in FIG. 1 may contain multiple optical fibers 40, while co-axial fiber optic line 10 illustrated in FIG. 2 may contain only a single optical fiber 40. It will also be understood that any number of optical fibers 40 able to fit within fiber optic line 10 and still allow adequate flow of a fluid or movement of deleterious chemicals out of fiber optic line 10 may be used.

As shown in FIG. 3, fiber optic line 10 may be connected to a sensor 110 and may be located inside of a tubing string 120 in casing 100 in a wellbore. Sensor 110 may be separate from or integrally formed with fiber optic line 10. Sensor 110 may be able to sense one or more properties inside casing 100 in a wellbore, such as temperature, pressure, strain, or acoustic noise. Sensor 110 may be an optical sensor, such as that described in U.S. Pat. No. 7,159,468, incorporated in material part by reference herein.

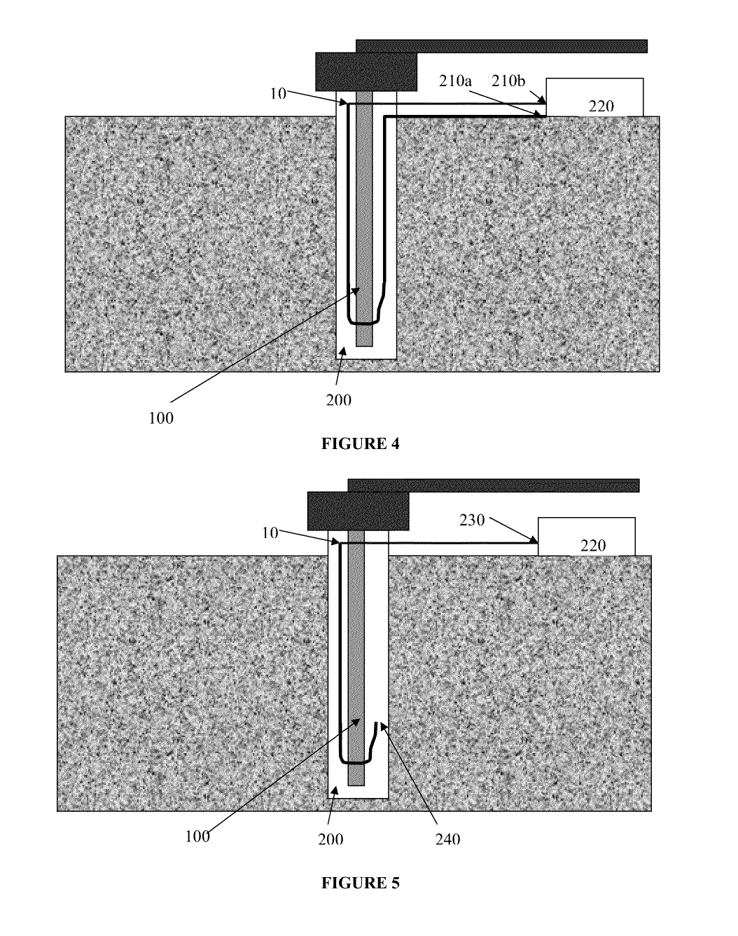

Embodiments of the type shown in FIG. 3 may be used in particular with systems in which fiber optic line 10 is introduced into a wellbore then removed. In alternative embodiments, fiber optic line 10 may be located outside of tubing string 90 or casing 100. Such alternative embodiments may be used in particular with systems in which fiber optic line 10 is permanently introduced into the wellbore or remains in place in the wellbore for at least several weeks. These alternative embodiments may in particular be useful with the configurations shown in FIGS. 4 and 5.

As shown in FIG. 4, fiber optic line 10 may be present in wellbore 200 in a U-tube installation. In this configuration, both ends 210a and 210b of fiber optic line 10 are present at the surface of wellbore 200. At the surface, one (not shown) or both ends 210a and 210b may be connected to fluid controller 220.

In one embodiment of the present disclosure, a fluid for removal of one or more deleterious chemicals may be introduced into fiber optic line 10 at one end 210a at fluid controller 220. The fluid may then flow through fiber optic line 10 and exit via opposite end 210b in order to purge deleterious chemicals from fiber optic line 10. The fluid may be flowed continuously through fiber optic line 10, or it may be flowed in intermittent cycles. Furthermore, the fluid may generally be flowed in one direction through fiber optic line 10, or it may periodically be flowed in opposite directions.

When the fluid is a gas, such as nitrogen gas, the volume over time desired to be flowed through fiber optic line 10 in order to remove all or substantially all of selected deleterious chemicals from fiber optic line 10 may be as little or one to three times the volume of inner volume 30 per day. The desirable total volume or volume over time of particular fluids may depend on the nature of the fluid used and the nature of the deleterious chemicals to be removed.

If the fluid or the deleterious chemical is a liquid that becomes gaseous in the wellbore, the total volume of fluid or volume over time desired to be flowed through fiber optic line 10 may also be affected by these properties. For instance, a deleterious chemical that is gaseous deep in wellbore 200 that condenses and forms a liquid on the path out of wellbore 200 may have a tendency to then drain back down fiber optic cable 10 away from end 210b. In such an instance, increased fluid volumes in total or an increased volume of fluid over time may be needed to adequately remove the deleterious chemical. Alternatively, fluids may be provided in stages with a first stage to blow the deleterious material into a zone of fiber optic line 10 where it condenses, followed, after allowing time for condensation, by a higher pressure second stage to blow the liquid material up and out of end 210b.

According to one embodiment, fluid controller 220 may include a fluid reservoir, such as a nitrogen gas tank. In one embodiment, the fluid may be generated from air. For instance, fluid controller 220 may contain an active gas separation apparatus able to generate nitrogen gas from air rather than a nitrogen gas tank. Fluid controller 220 may also include a flow control or pressurization unit. The flow control may include a regulator or a pump. In one embodiment, it may be a simple pneumatic pump or an air compressor. A pressurizing device may be used in particular with liquids, foams, or gels. Fluid controller 220 may also include a flow meter to allow adjustment of the flow rate of fluid leaving the fluid reservoir. In some embodiments, fluid controller 220 may include a reservoir for spent fluid. In instances where the fluid is a gas, the reservoir may have a volume selected to encourage movement of the gas into the reservoir. In sealed systems in which pressure in the reservoir may exceed atmospheric pressure, a regulator may be placed between the reservoir and fiber optic line 10 to prevent blow-back of the fluid into fiber optic line 10 in the event of any breach. In other embodiments, the fluid may be recirculated through fiber optic line 10, for instance using a recirculation loop in fluid controller 220. Deleterious materials may be removed from the fluid by a condensation trap. The condensation trap may be designed to trap expected amounts of deleterious materials for a selected period of time, such as at least a month or at least a year. In another embodiment, the fluid controller may contain a vacuum pump or a foam generator.

In some embodiments, fiber optic line 10 may be sealed. Connections with and within fluid controller 220 may also be sealed. In general, sealed configurations may be used when the fluid is volatile or will be substantially lost to outside air or when water vapor is regularly present in sufficient quantities in outside air to be introduced in deleterious amounts into fiber optic line 10. In addition to seals, condensation traps, such as liquid nitrogen or Peltier cold finger condensation traps may be used to avoid deleterious amounts of water vapor or other deleterious material in fiber optic line 10. Condensation traps may cycle periodically to remove the trapped material from the system. Seals and condensation traps may also be used at any part of the fiber optic line to prevent blow-back in case the fiber optic line is breached in the wellbore, allowing high pressure fluids to travel through the line.

In an alternative embodiment, shown in FIG. 5, fiber optic line 10 may be present in wellbore 200 in a J-tube installation. In this configuration, surface end 230 of fiber optic line 10 is present at the surface of wellbore 200 and connected to fluid controller 220. The well end 240 is located in the wellbore. A J-tube installation may be similar to the U-tube installation described above. However, in a J-tube installation, both ends of fiber optic line 10 are not connected to fluid controller 220. As a result, the fluid may either be pumped into fiber optic line 10 at surface end 230 and then removed again from that end, or it may be pumped into fiber optic line 10 at end 230 and then allowed to exit at well end 240. Typically well end 240 may contain one or more one-way valves in series to prevent wellbore materials from entering fiber optic line 10. Fluid will exit the one or more one-way valves appropriate to the pressure in fiber optic line 10 exceeds a certain pressure at which the valves are configured to open. Typically such a pressure may be 500 psi. In embodiments where it is not desirable for fluid to exit fiber optic line 10 via the one or more one-way valves in series, fluid pressure near well end 240 may be maintained below a maximum to avoid accidental loss of fluid through the one or more one-way valves in series.

In a J-tube configuration in which fluid does not typically exit through well end 240, but instead is removed through surface end 230, fluid may be provided cyclically. In any J-tube configuration, the total volume or volume over time of fluid provided may vary from that of a U-tube configuration, even for the same fluid and the same detrimental chemicals to be removed.

According to one embodiment in which fluid is pumped into the fiber optic line 10 at a pressure then removed via pressure release, fluid controller 220 may contain a valve, such as a solenoid valve, that may be activated to allow pressure release and removal of the fluid.

In general, a gaseous fluid may be preferred for use with J-tube configurations.

J-tube configurations or configurations, such as that shown in FIG. 5, in which fiber optic line 10 is inside of tubing string 90, may be preferred for use with co-axial fiber optic lines such as illustrated in FIG. 2, although non co-axial fiber optic lines such as illustrated in FIG. 1 are also compatible with these configurations. U-tube configurations may be preferred for use with non co-axial fiber optic lines such as illustrated in FIG. 1. Furthermore, a J-tube as opposed to a straight tube in a wellbore may also allow a liquid from condensation under pressure to form at the distal end. When a process is run and the fiber optic line pressure is changed, this material may be vaporized, then used, processed, or removed.

In any of the above embodiments, the temperature of the fiber optic line may vary significantly based on location and process. Accordingly, any of the above systems and methods may include elements (not shown) for heating one or more locations of fiber optic line 10 in order to cause internal components to migrate to other areas more suitable for removal of detrimental or undesirable materials or to facilitate the addition of beneficial materials or cause chemicals to be outgassed or otherwise released in the presence of the changed temperature. In other embodiments, sections of fiber optic line 10 may instead be cooled.

In one specific embodiment, at least of portion of the fiber optic line may be subjected to a thermal profile conducive to the release of deleterious chemicals, absorption of beneficial chemicals, or the improvement of the fiber coating cure. The thermal profile may be effected using any method to change the temperature in one or more portions of the fiber optic line, for instance by changing the temperature in the wellbore. According to once specific embodiment, such thermal profile may be effected by the wellbore fluids, or by the use of steam or other fluid sent down the wellbore from the surface, whether such operation is part of the normal operation of the well or done specifically to remove the deleterious chemicals.

According to another embodiment, the disclosure includes a system and method for removal of a contaminant or deleterious chemical from a fiber optic line wherein a system or method as described above in employed to removed materials from the fiber optic line, the materials are then analyzed to determine their content, and the system and method are modified based on the results of this determination for example to remove additional deleterious chemicals or undesirable materials, to add additional beneficial materials, or to otherwise adjust any heating, cooling, flowing, mixing, purging, or recombining

Although only exemplary embodiments of the invention are specifically described above, it will be appreciated that modifications and variations of these examples are possible without departing from the spirit and intended scope of the invention. For instance, one of ordinary skill in the art, using the information of this disclosure, may employ the system and method described herein to remove materials from or introduce materials to other lines similar to fiber optic lines. One of ordinary skill might also protect any internal sensor or signal component in such lines. As another example, certain embodiments discussed in this specification for illustrative purposes treat the fiber optic line as if it were a single line. One of ordinary skill in the art would recognize that the fiber optic line may actually contain multiple lines connected to one another so long as the fluid or vacuum may function as described above. Furthermore, the fiber optic line may contain multiple sensors. For instance, a fiber optic line containing multiple optical fibers may have multiple sensors at different locations in a wellbore, each connected to a different optical fiber.

1. A system for removal of deleterious chemicals from a fiber optic line, the system comprising:
a fiber optic line having two ends, an outer tube, an optical fiber, and an inner volume;
a fluid operable to move through the inner volume, the fluid operable to remove at least one deleterious chemical other than hydrogen from the fiber optic line; and
a fluid controller connected to at least one end of the fiber optic line and operable to control movement of the fluid through the inner volume.

2. The system according to claim 1, wherein at least a portion of the fiber optic line is located in a wellbore.

3. The system according to claim 2, wherein only one end of the fiber optic line is connected to the fluid controller and the other end is located in the wellbore.

4. The system according to claim 1, wherein the fiber optic line further comprises an inner tube, wherein the inner volume comprises a first inner volume located between the outer tube and the inner tube and a second inner volume located within the inner tube, and wherein the fluid flows in one direction through the first inner volume, and in the opposite direction through the second inner volume.

5. The system according to claim 1, wherein the at least one deleterious chemical comprises a chemical selected from the group consisting of water, alcohol, toluene, hydrogen sulfide, mineral spirits, hydrocarbons, N-methyl-2 pyrrolidone (NMP), outgassing byproducts from the optical fiber or coatings, a residual pumping solvent, and combinations thereof.

6. The system according to claim 1, wherein the fluid is additionally operable to remove hydrogen from the fiber optic line.

7. The system according to claim 1, wherein the fluid is a gas at surface pressure and temperature.

8. The system according to claim 1, wherein the fluid is nitrogen gas.

9. The system according to claim 1, wherein the fluid controller further comprises an apparatus operable to generate nitrogen gas.

10. The system according to claim 9, wherein the fluid controller further comprises an active gas separation apparatus operable to generate nitrogen gas from air.

11. The system according to claim 1, wherein the fluid is a liquid at surface pressure and temperature.

12. The system according to claim 1, wherein the fluid is a gel at surface pressure and temperature.

13. The system according to claim 1, wherein the fluid is a foam at surface pressure and temperature.

14. The system according to claim 1, wherein the fiber optic line comprises more than one optical fibers.

15. The system according to claim 1, wherein at least of portion of the fiber optic line is subjected to a thermal profile conducive to the release of deleterious chemicals, absorption of beneficial chemicals, or the improvement of the fiber coating cure.

16. The system according to claim 15, wherein at least a portion of the fiber optic line is located in a wellbore, and wherein the thermal profile is effected by a wellbore fluid, or by a fluid provided to the wellbore from the surface.

17. A method of removing a deleterious chemical from a fiber optic line comprising:
introducing a fluid into an inner volume of a fiber optic line at an end of the fiber optic line, wherein the inner volume is located within an outer tube; and
flowing the fluid through the inner volume of the fiber optic line in an amount and for a time sufficient to remove at least one deleterious chemical other than hydrogen from the fiber optic line.

18. The method according to claim 17, further comprising removing the fluid and at least one deleterious chemical at a different end of the fiber optic line.

19. The method according to claim 17, further comprising removing the fluid at the same end of the fiber optic line.

20. The method according to claim 17, wherein the at least one deleterious chemical comprises a chemical selected from the group consisting of water, alcohol, toluene, hydrogen sulfide, mineral spirits, hydrocarbons, N-methyl-2 pyrrolidone (NMP), outgassing byproducts from the optical fiber or coatings, a residual pumping solvent, and combinations thereof.

21. The method according to claim 17, further comprising flowing the fluid through the volume of the fiber optic line in an amount and for a time sufficient to additionally remove hydrogen from the fiber optic line.

22. The method according to claim 21, wherein the fluid is a gas at surface pressure and temperature.

23. The method according to claim 22, wherein the fluid is nitrogen gas.

24. The method according to claim 23, further comprising generating the nitrogen gas using an active gas separation apparatus operable to generate nitrogen gas.

25. The method according to claim 17, wherein the fluid is a liquid at surface pressure and temperature.

26. The method according to claim 17, wherein the fluid is a foam at surface pressure and temperature.

27. The method according to claim 17, wherein the fluid is a gel at surface pressure and temperature.

28. The method according to claim 17, further comprising subjecting at least a portion of the fiber optic line is subjected to a thermal profile conducive to the release of deleterious chemicals, absorption of beneficial chemicals, or the improvement of the fiber coating cure.

29. The method according to claim 28, wherein the fiber optic line is located in a wellbore, further comprising effecting the thermal profile using a wellbore fluid or fluid provided to the wellbore from the surface.

30. A method of removing a deleterious chemical from a fiber optic line comprising:
introducing a vacuum in an inner volume of a sealed fiber optic line, wherein the inner volume is located within an outer tube; and
maintaining or cycling the vacuum for a time sufficient to remove at least one deleterious chemical from the fiber optic line.

31. The method according to claim 30, wherein the at least one deleterious chemical comprises a chemical selected from the group consisting of water, alcohol, toluene, hydrogen sulfide, mineral spirits, hydrocarbons, N-methyl-2 pyrrolidone (NMP), outgassing byproducts from the optical fiber, a residual pumping solvent, and combinations thereof.
